(19) United States
(12) Patent Application Publication
(10) Pub. No.: US 2026/0213927 A1
(43) Pub. Date: Jul. 23, 2026

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventors: Sho NAGASE, Kanagawa (JP); Masahiko Harada, Kanagawa (JP); Atsushi Mori, Kanagawa (JP); Ryosuke Nakai, Kanagawa (JP)

(73) Assignee: FUJIFILM Business Innovation Corp., Tokyo (JP)

(21) Appl. No.: 19/287,474

(22) Filed: Jul. 31, 2025

(30) Foreign Application Priority Data
Jan. 23, 2025 (JP) 2025-009616

(51) Int. Cl. H04L 9/08

(52) U.S. Cl. CPC H04L 9/0825

(57) ABSTRACT

An information processing system includes: a processor; a first memory that is undetachable; and a second memory that is detachable, the processor being configured to: after occurrence of a state where the system does not operate normally, display information regarding an encryption key for decrypting data stored in the first memory, the information being stored in the second memory.

### CROSS-REFERENCE TO RELATED APPLICATIONS

This application is based on and claims priority under 35 USC 119 from Japanese Patent Application No. 2025-009616 filed Jan. 23, 2025.

### BACKGROUND

### (i) Technical Field

The present disclosure relates to an information processing system, a non-transitory computer readable medium, and an information processing method.

### (ii) Related Art

In recent years, security of an information processing apparatus such as an image processing apparatus is increasingly required. For example, in storing data considerable for a user in a memory device, the data is required to be encrypted on occasions.

Some image processing apparatuses are equipped with a detachable memory and an undetachable memory. To store encrypted data in the detachable memory, an encryption key for encrypting the data is stored in the undetachable memory. For this reason, if the detachable memory is detached and then attached to a different image processing apparatus, it is not possible to decrypt the information in the detachable memory.

Japanese Unexamined Patent Application Publication No. 2016-170621 discloses processing for displaying an error by using a bar code or the like, the error occurring while platform software is running.

Japanese Unexamined Patent Application Publication No. 2008-236092 discloses a data recovery method by which an encryption key for encrypting a detachable memory device is printed on paper while a controller board is normally operating and is read by a scanner at the time of recovery.

Japanese Unexamined Patent Application Publication No. 2019-212958 discloses an image forming apparatus that encrypts anomaly-related information at the time of an anomaly and then displays the information by using a two-dimensional code.

Japanese Unexamined Patent Application Publication No. 2008-293085 discloses an information processing apparatus that displays a two-dimensional code generated from data serving as a source of a password, reads the two-dimensional code, and generates the password from the content of the read code.

Japanese Unexamined Patent Application Publication No. 2010-211394 discloses an information reporting method by which in response to detection of fault information, a two-dimensional code including the fault information is generated and displayed.

### SUMMARY

Aspects of non-limiting embodiments of the present disclosure relate to providing an information processing system, a non-transitory computer readable medium, and an information processing method that are enabled to decrypt data stored in a detachable memory even if a detachable memory is moved from an information processing apparatus not operating normally to a different information processing apparatus, the detachable memory storing data encrypted by using an encryption key varying with the information processing apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: a processor; a first memory that is undetachable; and a second memory that is detachable, the processor being configured to: after occurrence of a state where the system does not operate normally, display information regarding an encryption key for decrypting data stored in the first memory, the information being stored in the second memory.

### BRIEF DESCRIPTION OF THE DRAWINGS

An exemplary embodiment of the present disclosure will be described in detail based on the following figures, wherein:

FIG. 1 is a view illustrating an example of the configuration of an information processing system of the exemplary embodiment;

FIG. 2 is a view illustrating the hardware configuration of an image processing apparatus of the exemplary embodiment;

FIG. 3 is a block diagram illustrating the functional configuration of the image processing apparatus of the exemplary embodiment;

FIG. 4 is a view of the hardware configuration of a mobile terminal apparatus of the exemplary embodiment;

FIG. 5 is a block diagram illustrating the functional configuration of the mobile terminal apparatus of the exemplary embodiment;

FIG. 6 is a flowchart illustrating an example of operations in the information processing system of the exemplary embodiment;

FIG. 7 is a view illustrating an example of an error screen displayed on a UI panel in the exemplary embodiment; and

FIG. 8 is a flowchart illustrating an example of operations in a first image processing apparatus of the exemplary embodiment.

### DETAILED DESCRIPTION

An information processing system 10 of an exemplary embodiment of the present disclosure will be described in detail with reference to the drawings.

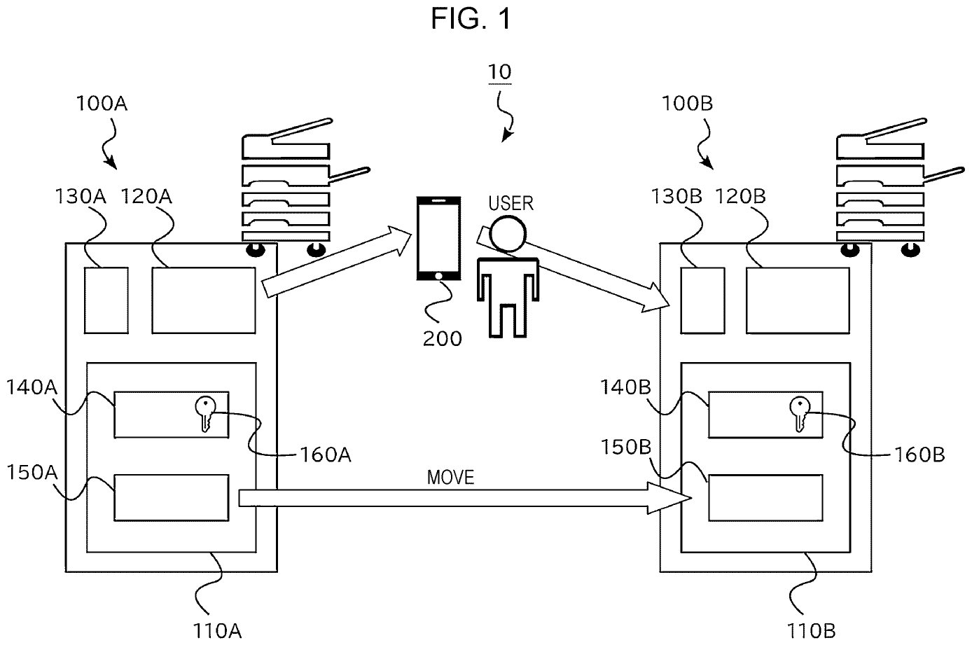

FIG. 1 is a view illustrating an example of the configuration of the information processing system 10 of an exemplary embodiment of the present disclosure. The information processing system 10 includes a first image processing apparatus 100A, a second image processing apparatus 100B, and a mobile terminal apparatus 200. The mobile terminal apparatus 200 is a mobile computer such as a smartphone or a tablet computer.

The first image processing apparatus 100A includes a control board 110A, a UI panel 120A, and a proximity wireless communication module 130A. The control board 110A has a first memory 140A and a second memory 150A. The first memory 140A is an undetachable memory. The second memory 150A is a detachable memory. The first memory 140A stores an encryption key 160A. The encryption key 160A is used to encrypt data to be stored in the second memory 150A. The second memory 150A stores the data encrypted with the encryption key 160A.

The second image processing apparatus 100B includes a control board 110B, a UI panel 120B, and a proximity wireless communication module 130B. The control board 110B has a first memory 140B and a second memory 150B. The first memory 140B is an undetachable memory. The second memory 150B is a detachable memory. The first memory 140B stores an encryption key 160B. The encryption key 160B is used to encrypt data to be stored in the second memory 150B. The second memory 150B stores the data encrypted with the encryption key 160B.

If the first image processing apparatus 100A does not operate normally, the second memory 150A is detached from the first image processing apparatus 100A and attached to the second image processing apparatus 100B. The second memory 150A is thus moved to the control board 110B of the second image processing apparatus 100B. In this case, it is not possible to decrypt data in the newly attached second memory 150A with the encryption key 160B in the first memory 140B. For this reason, it is not possible to read out the data stored in the first memory 140B. To use the data in the second memory 150A in the second image processing apparatus 100B, the encryption key 160A for the first image processing apparatus 100A is required.

In this exemplary embodiment, after the occurrence of a state where the system of the first image processing apparatus 100A does not operate normally, key information that is information regarding the encryption key 160A is displayed. The key information is information including the encryption key 160A. The key information may thus be the encryption key 160A itself. Alternatively, the key information may be information obtained by encrypting the encryption key 160A itself with a secret key in a public-key encryption method. Alternatively, the key information may be information obtained by adding failure information to the encryption key 160A. Alternatively, the key information may be information obtained by encrypting information including the encryption key 160A and failure information added to the encryption key 160A, with a secret key in the public-key encryption method.

In addition, the system of the first image processing apparatus 100A may include an image forming unit, a scanner, and a sheet feeder. The system may also include image processing software, a printer driver, and a communication function. The system thus includes at least one of components required to implement the functions of an image processing apparatus.

The state where the system does not operate normally includes a state where an anomaly occurs in one or more of the components. The state may also include, for example, a state where a failure occurs or a malfunction occurs in transmitting or receiving a signal to and from the component. The state where the system does not operate normally does not include a state that is undisplayable on the UI panel 120A. In addition, the state where the system does not operate normally does not include a state where it is not possible to perform initialization of a CPU 112A (described later), the first memory 140A, and the UI panel 120A, error check, firmware reading, or the like.

Further, time after the occurrence of the state where the system does not operate normally includes time immediately after the occurrence of the state where the system does not operate normally. The time after the occurrence of the state where the system does not operate normally may also include time when the system is started next. Alternatively, the time after the occurrence of the state where the system does not operate normally may include time after the system is started multiple times. The time after the occurrence of the state where the system does not operate normally thus denotes a period in which a malfunction continues or a period in which a fault continues.

The displayed key information is read by the mobile terminal apparatus 200. The second image processing apparatus 100B acquires the key information from the mobile terminal apparatus 200 through wireless communication. To perform the wireless communication, the second image processing apparatus 100B uses the proximity wireless communication module 130B. The information regarding the encryption key 160B stored in the first memory 140B is then overwritten with a new encryption key 160A.

The data in the second memory 150A moved to the second image processing apparatus 100B may then be read out.

Hereinafter, the configuration of the components of the first image processing apparatus 100A and the second image processing apparatus 100B will be described. The first image processing apparatus 100A and the second image processing apparatus 100B have the same configuration. Accordingly, only the first image processing apparatus 100A will be described as a representative.

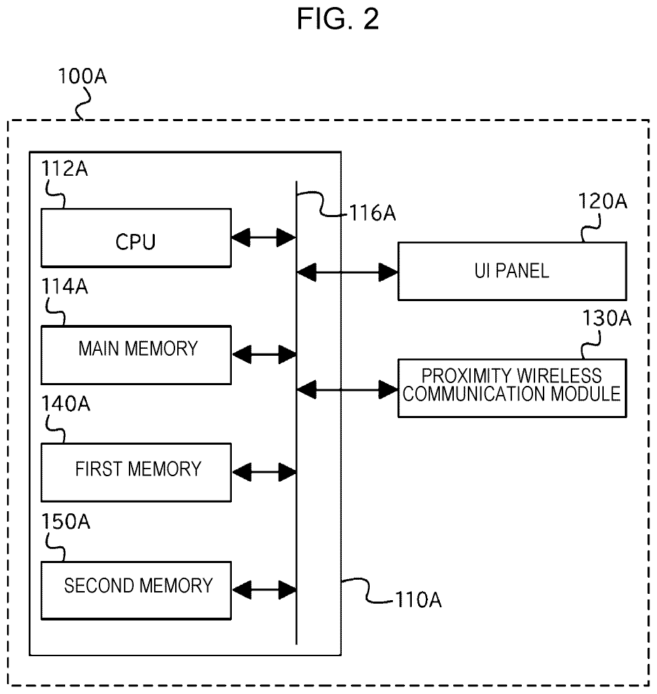

FIG. 2 is a view illustrating the hardware configuration of the first image processing apparatus 100A. As illustrated in FIG. 2, the control board 110A of the first image processing apparatus 100A has the CPU 112A and a main memory 114A. The first image processing apparatus 100A has the UI panel 120A and the proximity wireless communication module 130A. The control board 110A also has the first memory 140A undetachable from the control board 110A. Further, the first image processing apparatus 100A includes the detachable second memory 150A. The components are connected to each other via a control bus 116A.

The CPU 112A performs predetermined processing on the basis of a control program and thereby performs control of the operations of the first image processing apparatus 100A. The control program is stored in one of the main memory 114A, the first memory 140A, and the second memory 150A.

The main memory 114A is a volatile memory that temporarily stores data and programs required for the operations of the first image processing apparatus 100A. The main memory 114A is used as a temporary active region for firmware and application programs of the first image processing apparatus 100A. Further, the main memory 114A is used to temporarily store data in forming a scanned image and an image in a recording medium.

The first memory 140A is a non-volatile memory such as an EEPROM, a FlashROM, or a trusted platform module (TPM). It is not possible to detach the first memory 140A from the control board 110A. The first memory 140A stores information required for the basic operations of the first image processing apparatus 100A. The information required for the basic operations of the first image processing apparatus 100A includes firmware and security-related data. The first memory 140A stores a control program for controlling the components of the first image processing apparatus 100A. The first memory 140A also stores the encryption key 160A for encrypting data to be stored in the second memory 150A.

The case where the control program is installed in the first memory 140A has been described for this exemplary embodiment; however, the present disclosure is not limited to this case. The control program according to this exemplary embodiment may be provided in such a manner as to be stored in a computer readable storage medium. For example, the control program according to this exemplary embodiment may be provided in such a manner as to be recorded in an optical disk such as a compact disc (CD)-ROM or a digital versatile disc (DVD)-ROM or in a semiconductor memory such as a universal serial bus (USB) memory or a memory card. The control program according to this exemplary embodiment may be acquired from an external apparatus via communication network connected to a communication interface.

The second memory 150A is a memory card such as a ROM soldered onto a solid state drive (abbreviated as a SSD), a hard disk drive (abbreviated as a HDD), a SD card, or a small board connectable with a connector. The second memory 150A is used as an additional storage or an expanded memory. The second memory 150A is detachable from the control board 110A of the first image processing apparatus 100A or from the first image processing apparatus 100A. The second memory 150A stores user setting information, scan data, a template, and specific application module data. At least part of the information to be stored in the second memory 150A is encrypted with the encryption key 160A stored in the first memory 140A. The encryption key 160A has an initial value specific to the control board 110A, but a user may generate and reset a different value.

The UI panel 120A is an input-output device composed of a liquid crystal display and a touch panel that are provided to the first image processing apparatus 100A. After the occurrence of the state where the system of the first image processing apparatus 100A does not operate normally, the key information stored in the first memory 140A is displayed on the UI panel 120A. Various screens are displayed on the liquid crystal display serving as a component of the UI panel 120A. The user operates the touch panel as a component of the UI panel 120A, and thereby operation and input by the user are received.

The proximity wireless communication module 130A includes a radio communication chip set, an antenna, a controller, and an interface circuit. The proximity wireless communication module 130A transmits and receives data in a range from several centimeters to several meters or larger. The proximity wireless communication module 130A is, for example, a near field communication (NFC) module. The proximity wireless communication module 130A may be a Bluetooth (registered trademark) communication module or a WiFi (registered trademark) communication module.

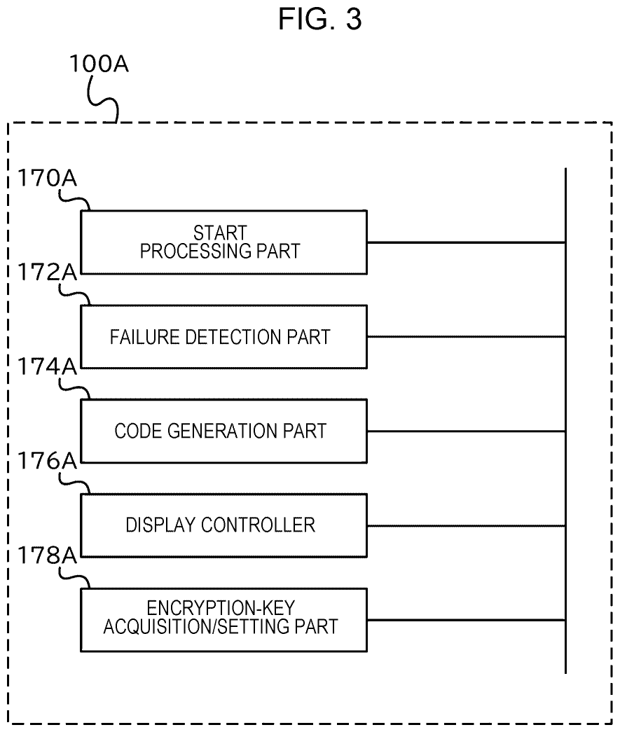

The functional configuration of the first image processing apparatus 100A will then be described with reference to FIG. 3. FIG. 3 is a block diagram illustrating the configuration of the functions of the first image processing apparatus 100A implemented in such a manner that the CPU 112A runs the control program.

As illustrated in FIG. 3, the first image processing apparatus 100A includes a start processing part 170A, a failure detection part 172A, a code generation part 174A, a display controller 176A, and an encryption-key acquisition/setting part 178A.

The start processing part 170A executes a process for starting the system. The system start process includes at least initialization of the CPU 112A, the first memory 140A, and the UI panel 120A, error check, and firmware reading. The system start process may further include verification of the state of initial hardware and the initialization of the components of the first image processing apparatus 100A. The system start process may include processes executed in starting the system, such as set data reading and network connection establishment.

The start processing part 170A determines whether a failure flag (described later) is set in the first memory 140A. The start processing part 170A thereby decides whether to continue the start process. If the failure flag is set in the first memory 140A, the start processing part 170A instructs the display controller 176A to display a two-dimensional code image (described later). The start processing part 170A thus causes the key information to be displayed as the two-dimensional code image on the UI panel 120A in the system start process after the occurrence of the state where the system of the first image processing apparatus 100A does not operate normally.

The failure detection part 172A detects the state where the system does not operate normally while the components of the first image processing apparatus 100A are operating. For example, if an anomaly occurs in at least one of the components required to implement the functions of an image processing apparatus such as an image forming unit, a scanner, a sheet feeder, image processing software, a printer driver, and a communication function, the failure detection part 172A sets the failure flag in the first memory 140A. Specifically, in response to the reception of an error signal, the failure detection part 172A sets the failure flag in the first memory 140A. The error signal is transmitted from one of the components of the system if the component does not operate normally.

If the failure detection part 172A determines that the system does not operate normally, the code generation part 174A generates key information. That is, the code generation part 174A generates the key information by encrypting the encryption key 160A stored in the first memory 140A or encrypting information including the encryption key 160A and failure information added to the encryption key 160A. For the encryption, a secret key in the public-key encryption method is used. The code generation part 174A then converts the generated key information into a two-dimensional code image and stores the key information in the first memory 140A.

For this exemplary embodiment, a case where the two-dimensional code image is generated when the failure detection part 172A detects an anomaly will be described. However, the present disclosure is not limited to this case. The two-dimensional code image may be generated if the failure flag is detected during the start process by the start processing part 170A. Alternatively, the two-dimensional code image may be generated when the encryption key 160A is stored in the first memory 140A. The two-dimensional code image may also be generated when the start processing part 170A instructs the display controller 176A to display the two-dimensional code image.

The display controller 176A performs display control of the UI panel 120A. Specifically, in response to the instruction from the start processing part 170A, the display controller 176A displays the two-dimensional code image on the UI panel 120A. The display controller 176A may display an error screen on the UI panel 120A together with the two-dimensional code image.

The encryption-key acquisition/setting part 178A acquires information regarding a new encryption key from the mobile terminal apparatus 200 through wireless communication. The encryption-key acquisition/setting part 178A uses the proximity wireless communication module 130A to perform the wireless communication. In response to the acquisition of the information regarding the new encryption key, the encryption-key acquisition/setting part 178A overwrites the encryption key 160A. The encryption-key acquisition/setting part 178A thus overwrites the encryption key 160A in the first memory 140A with the acquired information regarding the encryption key. In this exemplary embodiment, the information regarding the encryption key encrypted with the secret key is decrypted by the mobile terminal apparatus 200 as to be described later. However, the present disclosure is not limited to this. The encryption-key acquisition/setting part 178A may acquire the information regarding the encryption key still in the encrypted state from the mobile terminal apparatus 200 and decrypt with a public key.

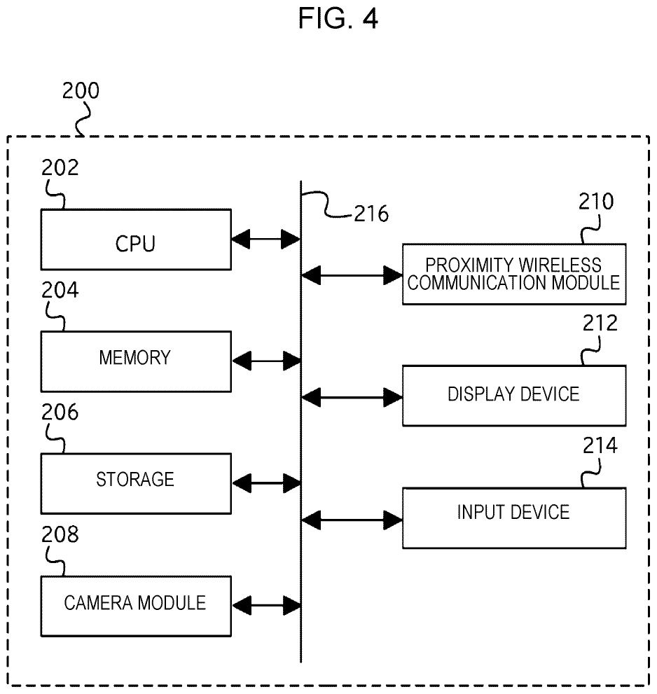

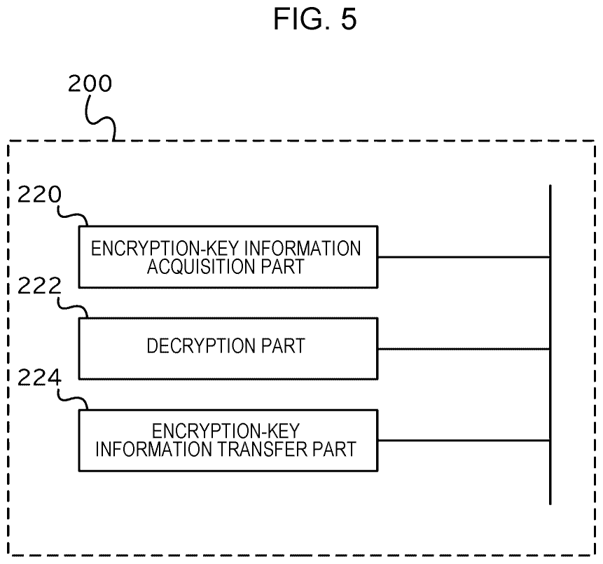

The mobile terminal apparatus 200 will then be described with reference to FIGS. 4 and 5. The mobile terminal apparatus 200 is held and operated by the user or a service person (hereinafter, referred to as a user). The user detaches the second memory 150A from the first image processing apparatus 100A and attaches the second memory 150A to the second image processing apparatus 100B.

FIG. 4 is a view of the hardware configuration of the mobile terminal apparatus 200, and FIG. 5 is a functional block diagram of the mobile terminal apparatus 200.

As illustrated in FIG. 4, the mobile terminal apparatus 200 includes a CPU 202, a memory 204, a storage 206, a camera module 208, a proximity wireless communication module 210, a display device 212, and an input device 214 which are connected to a control bus 216.

The CPU 202 is a control microprocessor. The CPU 202 performs control of the operations of the components of the mobile terminal apparatus 200 on the basis of a control program stored in the storage 206.

The memory 204 temporarily stores the two-dimensional code image imaged by the camera module 208. The memory 204 also temporarily stores the key information decoded from the two-dimensional code image.

The storage 206 is composed of a SSD or a HDD and stores the control program for controlling the components of the mobile terminal apparatus 200.

The camera module 208 includes a lens unit, an imaging sensor, and an image processing circuit. The camera module 208 performs imaging in response to operation of the input device 214 by the user. Image data resulting from the imaging is temporarily stored in the memory 204.

The proximity wireless communication module 210 includes a radio communication chip set, an antenna, a controller, and an interface circuit. The proximity wireless communication module 210 transmits and receives data in a range from several centimeters to several meters or larger. The proximity wireless communication module 210 is, for example, a NFC module. The proximity wireless communication module 210 may be a Bluetooth (registered trademark) communication module or a WiFi (registered trademark) communication module.

The display device 212 is composed of a liquid crystal panel, an organic EL display, or the like. Various images generated with the control program are displayed on the display device 212.

The input device 214 is composed of, for example, a capacitive touch panel formed on the surface of the display device 212. The user performs input operation by operating the input device 214 while looking at a user interface image displayed on the display device 212.

The functional blocks of the mobile terminal apparatus 200 will then be described with reference to FIG. 5. The mobile terminal apparatus 200 runs the control program stored in the storage 206. The mobile terminal apparatus 200 functions as an encryption-key information acquisition part 220, a decryption part 222, and an encryption-key information transfer part 224 in accordance with the control program.

The encryption-key information acquisition part 220 images a two-dimensional code image to be displayed on the UI panel 120A in response to the operation of the input device 214. The encryption-key information acquisition part 220 temporarily stores the image data resulting from the imaging in the memory 204.

The decryption part 222 acquires the key information stored in the memory 204 from the image data. The acquired key information is decrypted with a public key in the public-key encryption method. The encryption key 160A and the failure information that are acquired as a decryption result are temporarily stored in the memory 204.

When the mobile terminal apparatus 200 approaches the second image processing apparatus 100B in a predetermined distance, the encryption-key information transfer part 224 transmits the information regarding the encryption key 160A stored in the memory 204 to the second image processing apparatus 100B by using the proximity wireless communication module 210.

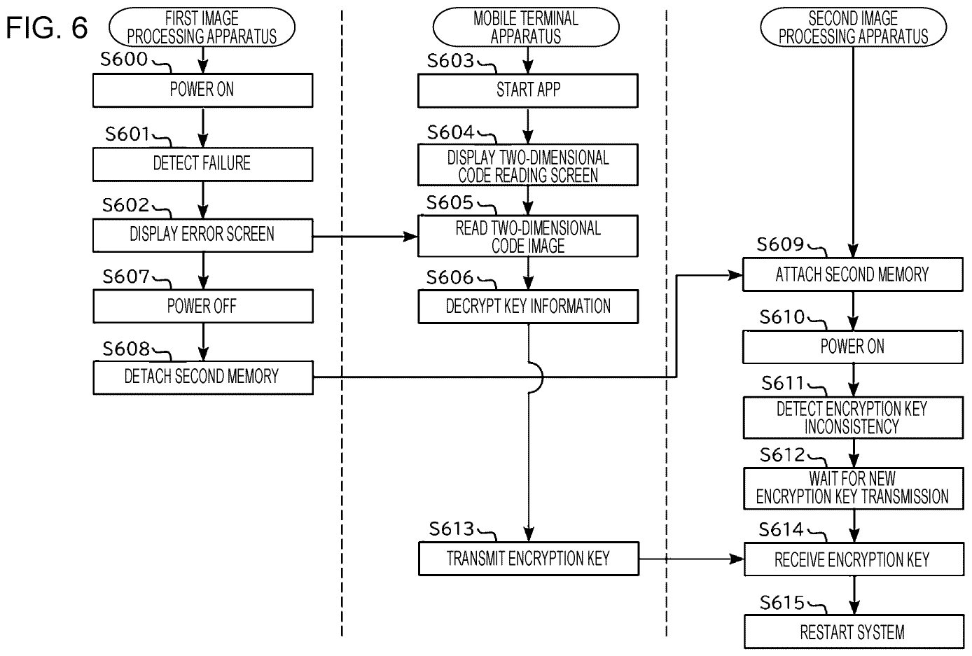

The operations in the information processing system 10 configured as described above will be described with reference to FIGS. 6 to 8. As illustrated in FIG. 6, in step S600, the first image processing apparatus 100A is powered on. In response to this, the start processing part 170A starts a process for starting the system of the first image processing apparatus 100A.

In step S601, the start processing part 170A detects a failure of the system. The start processing part 170A thus determines whether a failure flag is set. If a failure flag is set, the start processing part 170A determines that the system is not in a normal state.

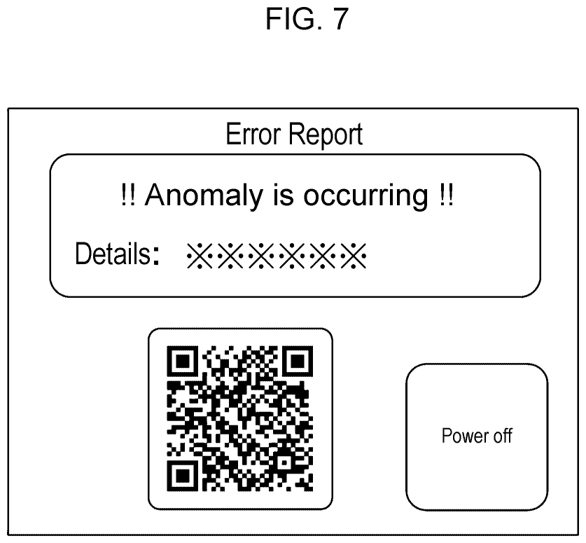

If the start processing part 170A determines that the system is not in a normal state, the processing proceeds to step S602. In step S602, the start processing part 170A instructs the display controller 176A to display an error screen including a two-dimensional code image. The display controller 176A displays the error screen illustrated in FIG. 7 on the UI panel 120A. The error screen includes a message indicating that the first image processing apparatus 100A does not operate normally and the two-dimensional code image. The two-dimensional code image is stored in advance in the first memory 140A. The display controller 176A acquires the two-dimensional code image in the first memory 140A and displays the two-dimensional code image on the UI panel 120A. In the exemplary embodiment, when the failure detection part 172A detects an anomaly, the two-dimensional code image is generated. Accordingly, the two-dimensional code image is stored in advance in the first memory 140A. However, the two-dimensional code image may be generated during the start process by the start processing part 170A. In this case, the code generation part 174A encrypts information regarding the encryption key 160A stored in the first memory 140A with a secret key in the public-key encryption method and thereafter converts the information into the two-dimensional code image. The converted two-dimensional code image is displayed by the display controller 176A on the UI panel 120A.

The processing then proceeds to step S603 that is to be performed by the mobile terminal apparatus 200. In step S603, the user operates the input device 214 of the mobile terminal apparatus 200 and thereby starts an application program.

In step S604, the encryption-key information acquisition part 220 displays the two-dimensional code reading screen on the display device 212. Further, the encryption-key information acquisition part 220 starts imaging by starting the camera module 208. An image as an imaging target by the camera module 208 is displayed on the display device 212.

In step S605, the encryption-key information acquisition part 220 determines whether the two-dimensional code image is captured in the imaging target image. If the two-dimensional code image is captured, the encryption-key information acquisition part 220 temporarily stores data in the two-dimensional code image in the memory 204. The imaging by the camera module 208 is then terminated.

In step S606, the decryption part 222 decodes the key information from the data in the two-dimensional code image. Further, the decryption part 222 decrypts the decoded information with a public key in the public-key encryption method. The decrypted encryption key 160A is temporarily stored in the memory 204.

The processing then proceeds to step S607 to be performed by the first image processing apparatus 100A. In step S607, the user powers off the first image processing apparatus 100A.

In step S608, the user detaches the second memory 150A of the first image processing apparatus 100A from the control board 110A.

The processing then proceeds to step S609 to be performed by the second image processing apparatus 100B. In step S609, the user attaches the second memory 150A to the control board 110B of the second image processing apparatus 100B. The second memory 150A thus replaces the second memory 150B of the second image processing apparatus 100B.

In step S610, the second image processing apparatus 100B is powered on. In response to this, a start processing part 170B starts a process for starting the system of the second image processing apparatus 100B.

In step S611, the start processing part 170B determines whether the content of the newly attached second memory 150B is able to be decrypted. The start processing part 170B thus determines whether the content of the second memory 150B is able to be decrypted with the encryption key 160B in the first memory 140B. If the content is not able to be decrypted, the start processing part 170B determines encryption key inconsistency.

In step S612, an encryption-key acquisition/setting part 178B instructs a display controller 176B to display a message indicating encryption key inconsistency. The display controller 176B displays, on the UI panel 120B, a report message image requesting the user to transmit an appropriate encryption key. The encryption-key acquisition/setting part 178B waits for information regarding the encryption key.

In step S613 to be performed by the mobile terminal apparatus 200, the user places the mobile terminal apparatus 200 near the proximity wireless communication module 130B of the second image processing apparatus 100B. In response to this, the encryption-key information transfer part 224 of the mobile terminal apparatus 200 transmits information regarding the encryption key 160A to the second image processing apparatus 100B. To transmit the information regarding the encryption key 160A, the encryption-key information transfer part 224 uses the proximity wireless communication module 210.

In step S614, the encryption-key acquisition/setting part 178B of the second image processing apparatus 100B receives the information regarding the encryption key 160A. The encryption-key acquisition/setting part 178B receives the information regarding the encryption key 160A by using the proximity wireless communication module 130B. The encryption-key acquisition/setting part 178B overwrites the information regarding the encryption key 160B with the information regarding the received encryption key 160A. In response to this, the content of the information stored in the second memory 150A becomes able to be decrypted with the newly stored encryption key 160A.

In step S615, the start processing part 170B restarts the system of the second image processing apparatus 100B. Alternatively, the user restarts the system of the second image processing apparatus 100B. Alternatively, the start processing part 170B executes the process for starting the system of the second image processing apparatus 100B. In the start process, the start processing part 170B decrypts set data in the second memory 150A with the new encryption key 160A and reads the set data. The read set data becomes usable for the system of the second image processing apparatus 100B.

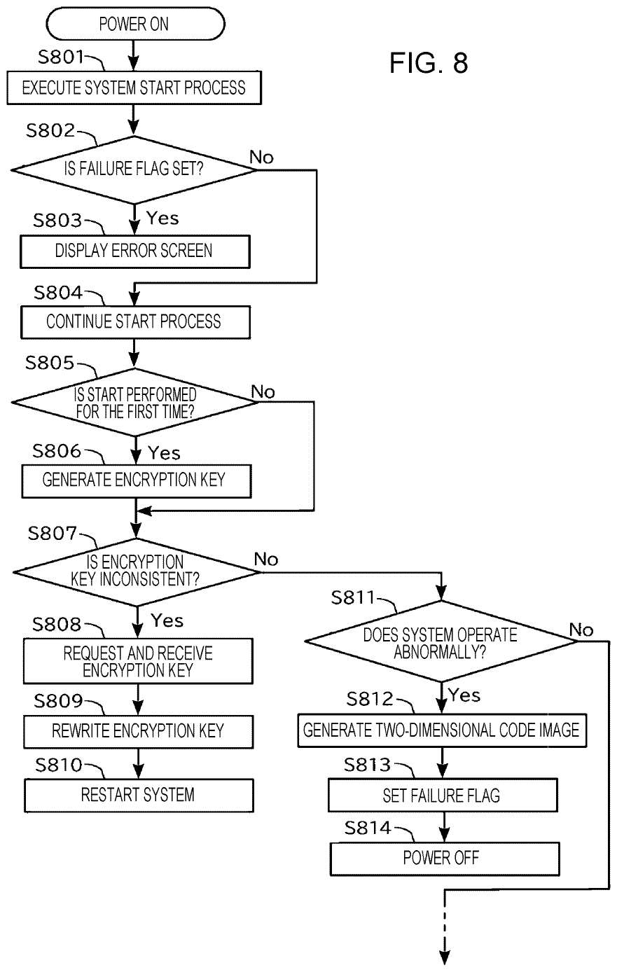

The operations in the information processing system 10 in this exemplary embodiment has heretofore been described. The operations of the first image processing apparatus 100A or the second image processing apparatus 100B will then be described with reference to FIG. 8. Hereinafter, the operations of only the first image processing apparatus 100A will be described. However, the first image processing apparatus 100A and the second image processing apparatus 100B have the same configuration. Accordingly, the following description is also applicable to the operations of the second image processing apparatus 100B.

In FIG. 8, the first image processing apparatus 100A is powered on. In response to this, the start processing part 170A executes the system start process in step S801. The start processing part 170A initializes at least the CPU 112A, the first memory 140A, and the UI panel 120A. The start processing part 170A may also perform error check of the CPU 112A, the first memory 140A, and the UI panel 120A. The start processing part 170A may also read firmware.

In step S802, the start processing part 170A determines whether a failure flag is set in the first memory 140A. If a failure flag is set, the processing proceeds to step S803. In step S803, the start processing part 170A instructs the display controller 176A to display an error screen including the two-dimensional code image. The display controller 176A displays the error screen illustrated in FIG. 7 on the UI panel 120A in response to the instruction from the start processing part 170A.

If the start processing part 170A determines in step S802 that a failure flag is not set, the processing proceeds to step S804, and the start process is continued.

In step S805, the start processing part 170A determines whether the system of the first image processing apparatus 100A is started for the first time. If the start is performed for the first time, the processing proceeds to step S806. In step S806, the encryption-key acquisition/setting part 178A generates the encryption key 160A. The encryption key 160A is used to encrypt data to be stored in the second memory 150A. The generated encryption key 160A is stored in the first memory 140A. The data to be stored in the second memory 150A is encrypted with the encryption key 160A. When the encryption key 160A is generated, the code generation part 174A may encrypt information regarding the encryption key 160A with a secret key in the public-key encryption method, convert the information into a two-dimensional code image, and store the two-dimensional code image in the first memory 140A. The processing then proceeds to step S807.

In step S805, the start processing part 170A determines that the system start is not performed for the first time, the processing proceeds to step S807. In step S807, the start processing part 170A determines whether the content of the second memory 150A is able to be decrypted with the encryption key 160A in the first memory 140A. If the content is not able to be decrypted, the start processing part 170A determines encryption key inconsistency, and the processing proceeds to step S808.

In step S808, the encryption-key acquisition/setting part 178A instructs the display controller 176A to display a message indicating encryption key inconsistency. The display controller 176A displays, on the UI panel 120A, a report message image requesting the user to transmit an encryption key. The encryption-key acquisition/setting part 178A waits for information regarding the encryption key. The encryption-key acquisition/setting part 178A receives the information regarding the encryption key from the mobile terminal apparatus 200. To receive the information regarding the encryption key, wireless communication using the proximity wireless communication module 130A is used.

In step S809, the encryption-key acquisition/setting part 178A overwrites information regarding the encryption key with the information regarding the acquired encryption key. In response to this, the content of the information stored in the second memory 150A becomes able to be decrypted with the encryption key newly stored in the first memory 140A.

In step S810, the start processing part 170B or the user restarts the system of the first image processing apparatus 100A.

If the start processing part 170A determines in step S807 that the content of the second memory 150A is able to be decrypted with the encryption key 160A in the first memory 140A, the start process is terminated. The processing then proceeds to step S811.

In step S811, the failure detection part 172A detects a state where the system does not operate normally. If the failure detection part 172A determines that the system of the first image processing apparatus 100A operates normally, the processing proceeds to a subsequent step (not illustrated). The first image processing apparatus 100A continues normal operations. In contrast, if the failure detection part 172A determines that the system of the first image processing apparatus 100A does not operate normally, the processing proceeds to step S812.

In step S812, the code generation part 174A encrypts the information regarding the encryption key 160A stored in the first memory 140A with a secret key in the public-key encryption method and further converts the information into a two-dimensional code image. The failure detection part 172A also generates failure information. The failure information indicates which part of the system of the first image processing apparatus 100A does not operate normally and how the part operates.

In step S813, the failure detection part 172A sets a failure flag in the first memory 140A. The failure detection part 172A stores the generated failure information in the first memory 140A. The code generation part 174A also stores the generated two-dimensional code image in the first memory 140A.

In step S814, the failure detection part 172A or the user powers off the first image processing apparatus 100A, and the processing is terminated.

The example where the key information, that is, the encryption key 160A or the encrypted information including this is displayed as the two-dimensional code image has heretofore been described, the key information being displayed in the system start process after the occurrence of the state where the system does not operate normally. However, the present disclosure is not limited to the above case. The two-dimensional code image may be displayed when predetermined operation is received after the occurrence of the state where the system does not operate normally. Examples of the predetermined operation include selecting a menu item for displaying a two-dimensional code of the key information. In this case, the failure detection part 172A instructs the code generation part 174A and the display controller 176A to display, on the UI panel 120A, the information regarding the encryption key 160A as the two-dimensional code image.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. The program in the present application may be provided as a program product.

In the embodiments above, the term “processor” is broad enough to encompass one processor or plural processors in collaboration which are located physically apart from each other but may work cooperatively. The order of operations of the processor is not limited to one described in the embodiments above, and may be changed.

The term “system” in this exemplary embodiment includes both of a system including multiple devices and a system including one device.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system includes:
a processor; a first memory that is undetachable; and a second memory that is detachable,
the processor being configured to: after occurrence of a state where the system does not operate normally, display information regarding an encryption key for decrypting data stored in the first memory, the information being stored in the second memory.
(((2)))

In the information processing system according to (((1))),
the processor is configured to: display the information regarding the encryption key in a process for starting the system after the occurrence of the state where the system does not operate normally.
(((3)))

In the information processing system according to (((1))),
the processor is configured to: in response to reception of predetermined operation after the occurrence of the state where the system does not operate normally, display the information regarding the encryption key.
(((4)))

In the information processing system according to (((2))) or (((3))),
the processor is configured to: encrypt and display the information regarding the encryption key, the information being encrypted with a secret key in a public-key encryption method.
(((5)))

In the information processing system according to (((4))),
the processor is configured to: display the information regarding the encryption key as a two-dimensional code.
(((6)))

In the information processing system according to (((1))),
the processor is configured to: in response to acquisition of information regarding a new encryption key, overwrite the encryption key stored in the first memory with the new encryption key.
(((7)))

In the information processing system according to (((6))),
the processor is configured to: acquire the information regarding the new encryption key through wireless communication.
(((8)))

A program causes a computer of an information processing system to execute a process, the information processing system including a processor, a first memory that is undetachable, and a second memory that is detachable, the process including:
after occurrence of a state where the information processing system does not operate normally, displaying information regarding an encryption key for decrypting data stored in the first memory, the information being stored in the second memory.

What is claimed is:

1. An information processing system comprising:
a processor;
a first memory that is undetachable; and
a second memory that is detachable,
the processor being configured to: after occurrence of a state where the system does not operate normally, display information regarding an encryption key for decrypting data stored in the first memory, the information being stored in the second memory.

2. The information processing system according to claim 1,
wherein the processor is configured to: display the information regarding the encryption key in a process for starting the system after the occurrence of the state where the system does not operate normally.

3. The information processing system according to claim 1,
wherein the processor is configured to: in response to reception of predetermined operation after the occurrence of the state where the system does not operate normally, display the information regarding the encryption key.

4. The information processing system according to claim 2,
wherein the processor is configured to: encrypt and display the information regarding the encryption key, the information being encrypted with a secret key in a public-key encryption method.

5. The information processing system according to claim 3,
wherein the processor is configured to: encrypt and display the information regarding the encryption key, the information being encrypted with a secret key in a public-key encryption method.

6. The information processing system according to claim 4,
wherein the processor is configured to: display the information regarding the encryption key as a two-dimensional code.

7. The information processing system according to claim 5,
wherein the processor is configured to: display the information regarding the encryption key as a two-dimensional code.

8. The information processing system according to claim 1,
wherein the processor is configured to: in response to acquisition of information regarding a new encryption key, overwrite the encryption key stored in the first memory with the new encryption key.

9. The information processing system according to claim 8,
wherein the processor is configured to: acquire the information regarding the new encryption key through wireless communication.

10. A non-transitory computer readable medium storing a program causing a computer of an information processing system to execute a process, the information processing system including a processor, a first memory that is undetachable, and a second memory that is detachable, the process comprising:
after occurrence of a state where the information processing system does not operate normally, displaying information regarding an encryption key for decrypting data stored in the first memory, the information being stored in the second memory.

11. An information processing method that is performed in an information processing system including a processor, a first memory that is undetachable, and a second memory that is detachable, the method comprising:
after occurrence of a state where the information processing system does not operate normally, displaying information regarding an encryption key for decrypting data stored in the first memory, the information being stored in the second memory.
